(19) United States
(12) Patent Application Publication
(10) Pub. No.: US 2014/0048610 A1
(43) Pub. Date: Feb. 20, 2014

(54) Assembly for a Modular Automation Device

(71) Applicants: Michael Abert, Au (DE); Valentin Kort, Landau (DE); Norbert Rottmann, Landau (DE)

(72) Inventors: Michael Abert, Au (DE); Valentin Kort, Landau (DE); Norbert Rottmann, Landau (DE)

(73) Assignee: SIEMENS AKTIENGESELLSCHAFT

(21) Appl. No.: 13/969,991

(22) Filed: Aug. 19, 2013

(30) Foreign Application Priority Data
Aug. 20, 2012 (EP) 12180971

(51) Int. Cl. G05D 23/01

(52) U.S. Cl. CPC G05D 23/01
USPC 236/93 R

(57) ABSTRACT

An assembly for a modular automation device includes a sensor, which is arranged in a housing capsule of the assembly, for detecting the temperature (T_{det}) of the feed air in the housing capsule, where feed air flows through air-inlet openings in the housing capsule, across components, and finally through air-outlet openings in the housing capsule, and includes a monitoring unit for evaluating the temperature (T_{det}) that is detected by the sensor such that the feed-air temperature can be determined more accurately by using suitable measures.

### BACKGROUND OF THE INVENTION

1. Field of the Invention

The invention relates to an assembly for a modular automation device, having a sensor, which is arranged in a housing capsule of the assembly, for detecting the temperature of the feed air in the housing capsule, where feed air flows through air-inlet openings in the housing capsule, across components, and finally through air-outlet openings in the housing capsule, and having a monitoring unit for evaluating the sensor that is detected by the sensor. The invention further relates to a modular automation device having a plurality of these types of assemblies.

2. Description of the Related Art

Siemens catalogue ST 70, chapter 5, issue 2011 discloses assemblies for a modular automation device. The assemblies, which can be mounted on a support, are a constituent part of a modular automation device and each have, within a housing capsule, a surface mount device (SMD) printed circuit board that is provided with electrical and electronic components. Heat is drawn from these components substantially by convection by means of air flowing through an opening in the lower face of the housing capsule, across the components, and finally through an opening in the upper face of the housing capsule, where the air that flows through the housing draws heat from the components. In many cases, the assemblies are designed for use in a harsh processing environment up to a predefined ambient temperature, and it is therefore necessary to know the feed-air temperature in the respective assembly during operation of the automation device to ensure that the assembly can operate at the ambient temperature which is specified for it.

In order to detect the temperature of the feed air, the SMD printed circuit board has an SMD sensor, where, if the temperature reaches or exceeds a threshold value, a temperature-monitoring unit indicates a fault to a user. Although the space requirement of the components on the printed circuit board is reduced on account of the SMD design, it is disadvantageous that the heat lost from the assembly has a disturbing influence on the SMD sensor with respect to accurate detection of the feed-in temperature. For example, heat sources that are arranged on the printed circuit board in the form of transformers or field-effect transistors corrupt the measurement result of the SMD sensor, i.e., the feed-air temperature that is detected by the sensor deviates from the actual feed-air temperature, where further interfering temperature influences that are caused by adjacent assemblies increase the deviations.

### SUMMARY OF THE INVENTION

It is therefore an object of the invention to provide an assembly for a modular automation device and a modular automation device having assemblies of this kind, which assemblies and automation device enable the feed-air temperature to be evaluated more accurately.

This and other objects and advantages are achieved in accordance with the invention by an assembly and automation device in which the feed-air temperature can be advantageously determined more accurately by determining deviations in the feed-air temperature and taking into consideration these deviations to correct the feed-air temperature that is detected by a sensor. Corruption of the measurement result with respect to the feed-air temperature on account of heat sources that are arranged on a printed circuit board and/or disturbing temperature influences that are caused by adjacent assemblies are largely avoided, this meaning that these disturbances are largely eliminated or compensated for during determination of the actual feed-air temperature. Furthermore, no additional production costs and no additional outlay on installation is required, such as a further sensor, which is arranged outside the assembly or housing capsule, for detecting a reference temperature can be dispensed with. It is only necessary to adapt the assembly firmware a single time, i.e., once.

At least one reference curve is stored in the monitoring unit for a performance parameter, where the reference curve represents, for this one performance parameter, the deviations in the detected temperature or a reference temperature as a function of the heat-up time or a cool-down time of the assembly. In order to achieve good results with respect to the feed-air temperature that is to be determined, it is not absolutely necessary to store a large number of reference curves in the monitoring unit for a large number of detectable temperatures, such as temperatures of from 10° C. to 70° C. In a practical exemplary embodiment of the invention, a reference curve for a reference temperature of 60° C. is selected only for three performance parameters, because it has been found that the temperature deviations differ only insignificantly from the deviations for temperatures of from 5 to 50° C. as a function of the heat-up time or operating period after the assembly is switched on.

It should be understood that a reference curve can be stored in the monitoring unit for any performance parameters and any of the detectable temperatures in the temperature range of from 10° C. to 70° C. to achieve particularly good results in respect of the evaluation. A performance parameter is understood to be, for example, operation of the assembly under full-load, half-load or quarter-load.

In another embodiment, it possible to simply calculate the feed-air temperature during the heat-up time of the assembly. The assembly is operated, for example, under half- or full-load during this heat-up time. In the case in which the assembly comprises a source module or a power-supply assembly, this means that the assembly provides or outputs 50 or 100% of its rated power to the further assemblies or sink modules. In the case in which the assembly is comprises a sink module or an assembly that receives power, this module or this assembly draws 50 or 100% of its power requirement from a source module or from a power-supply assembly.

In another embodiment, it is possible to simply calculate the feed-air temperature during the cool-down time of the assembly. An assembly that comprises a source module or a power-supply assembly does not supply any further assemblies with energy and an assembly that comprises a sink module or an assembly that receives power does not draw any current from the source module or the power-supply assembly during this cool-down time.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention, the refinements of said invention and advantages of said invention will be explained in greater detail below with reference to the drawing which illustrates an exemplary embodiment of the invention, in which:

FIGS. 1 and 2 show graphical plots of reference curves;

FIG. 3 shows an schematic block diagram of a modular automation device in accordance with the invention; and

FIG. 4 is a schematic block diagram of the modular automation device of FIG. 3 including a sensor and monitor.

### DETAILED DESCRIPTION OF THE PREFERRED EMBODIMENTS

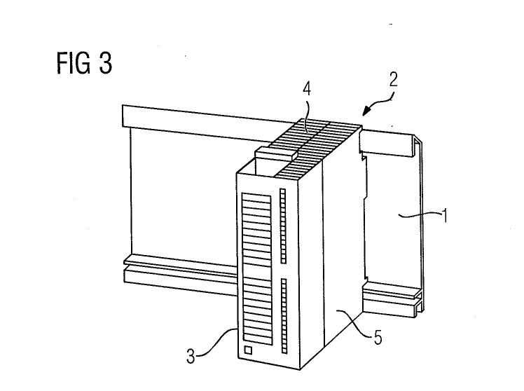

With initial reference to FIG. 3, shown therein is an assembly 2, which is known per se and is arranged on a support 1, of a modular automation device which has a plurality of assemblies. Heat is drawn from these components substantially by convection means of feed air flowing through openings (air-inlet openings) in the lower face of a housing capsule 3, across the electrical and electronic components of the assembly, and finally through an opening 4 (air-outlet openings) in the upper face of the housing capsule 2, where the air that flows through the housing capsule 3 draws heat from the components which are arranged or mounted on an SMD printed circuit board. The SMD printed circuit board is usually positioned or arranged in the housing capsule 3 parallel to the side wall 5 of the housing capsule 3 and has an SMD sensor for detecting the feed-air temperature.

In order to largely prevent heat sources that are arranged on the printed circuit board and/or disturbing temperature influences of adjacent assemblies (not illustrated) from corrupting the measurement result with respect to the feed-air temperature, provision is made for the feed-air temperature to be determined from the detected feed-air temperature and a time-dependent temperature deviation via a reference curve which is stored in a monitoring unit of the assembly. The reference curve represents, for a performance parameter, the deviations in the detected feed-air temperature or a reference temperature, which is associated with the detected feed-air temperature, as a function of a heat-up time or a cool-down time of the assembly. The disturbing influences are taken into account during the evaluation of the detected feed-air temperature and largely eliminated by such measures.

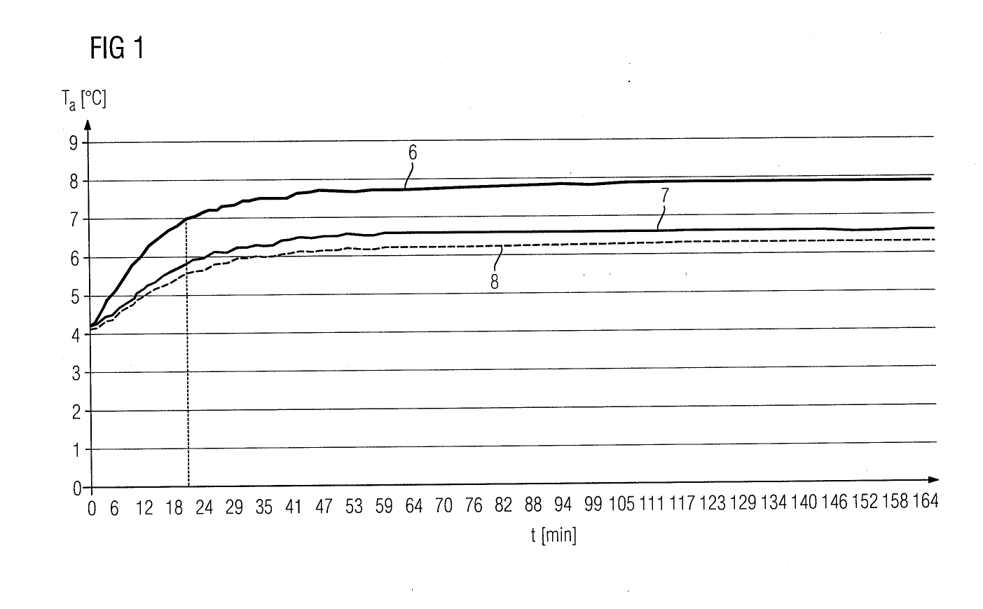

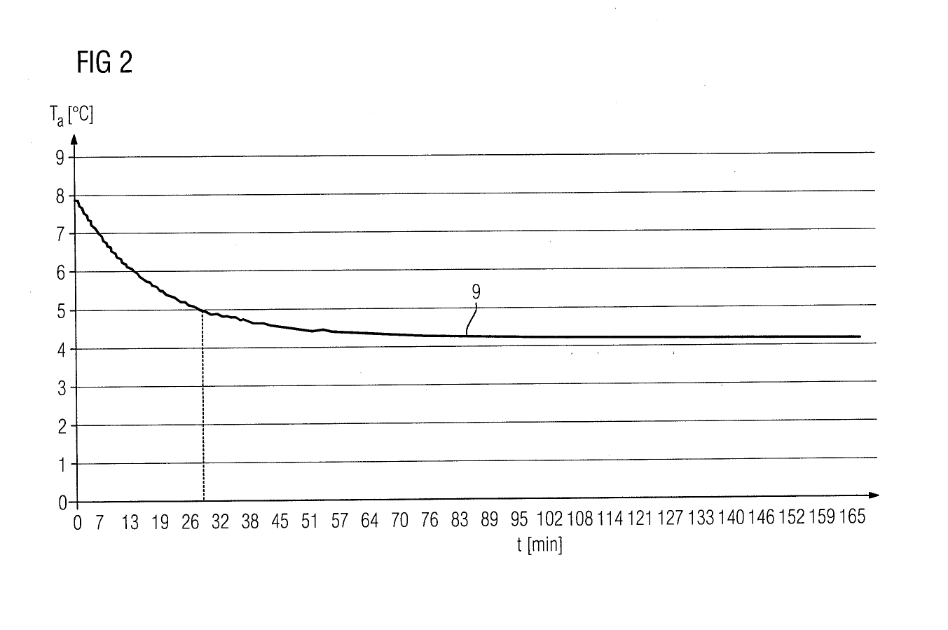

For a more detailed explanation in this respect, reference is made to FIGS. 1 and 2, which illustrate graphical plots of reference curves, in the text which follows.

FIG. 1 shows reference curves 6, 7, 8 that represent temperature deviations Tₐ as a function of a heat-up time tₕ of an assembly under full-load, half-load or quarter-load operation, where the reference temperature selected is 60° C. In the case of, for example, the sensor of the assembly detecting a feed-air temperature T_{det} of 50° C. and the assembly operating under full load for approximately 20 minutes, a monitoring unit determines a temperature deviation Tₐ of 7° C. via the reference curve 6 and calculates a feed-air temperature T_{z} of 43° C. from the detected feed-air temperature T_{det} of 50° C. and the temperature deviation of 7° C.

In general, the temperature deviation Tₐ during operation under load or during the heat-up phase for t>t₀ is:

$${T}_{a} = {T}_{s} + {T}_{e} \times ( 1 - {e}^{\frac{{t}_{h} - {t}_{0}}{T}} )$$

where:

tₕ: heat-up time,

t₀: delay or dead time,

T: time constant (approximately 15 minutes),

T_{z}: calculated feed-air temperature,

T_{det}: the detected feed-air temperature or reference temperature,

Tₐ: temperature deviation,

Tₛ: empirically determined temperature deviation at the beginning of the heating-up process, and

Tₑ: empirically determined temperature deviation at the end of the heating-up process.

The feed-air temperature T_{z} is generally:

T_{z}=T_{det}−Tₐ

In the text which follows, reference is made to FIG. 2 that shows a reference curve 9 that represents temperature deviations Tₐ as a function of a cool-down time tₖ of an assembly after full-load operation. Here, the assembly, such as a digital output assembly, no longer takes part in the process control operation, but the monitoring unit continues to be activated. In the case in which the assembly comprises a power-supply assembly, the assembly is switched to passive with respect to its power output. The monitoring unit is also still active in this case.

In the case in which, for example, the sensor of the assembly detects a feed-air temperature T_{det} of 50° C. during operation of the assembly and the assembly is not in operation for approximately 28 minutes, a monitoring unit determines a temperature deviation Tₐ of 5° C. via the reference curve 9 and calculates a feed-air temperature T_{z} of 45° C. from the detected feed-air temperature T_{det} of 50° C. and the temperature deviation Tₐ of 5° C.

In general, the temperature deviation Tₐ during the deactivation or cool-down phase for t>t₀ is:

$${T}_{a} = {T}_{ss} + {T}_{ee} \times {e}^{\frac{{t}_{k} - {t}_{0}}{T}}$$

where:

tₖ: cool-down time,

t₀: delay or dead time,

T: time constant,

T_{z}: calculated feed-air temperature,

T_{det}: the detected feed-air temperature or reference temperature,

Tₐ: temperature deviation,

Tₛₛ: empirically determined temperature deviation at the beginning of the cooling-down process which corresponds to the empirically determined temperature deviation Tₑ at the end of the heating-up process, and

Tₑₑ: empirically determined temperature deviation at the end of the cooling-down process.

In general, the feed-air temperature T_{z} is once again:

T_{z}=T_{det}−Tₐ

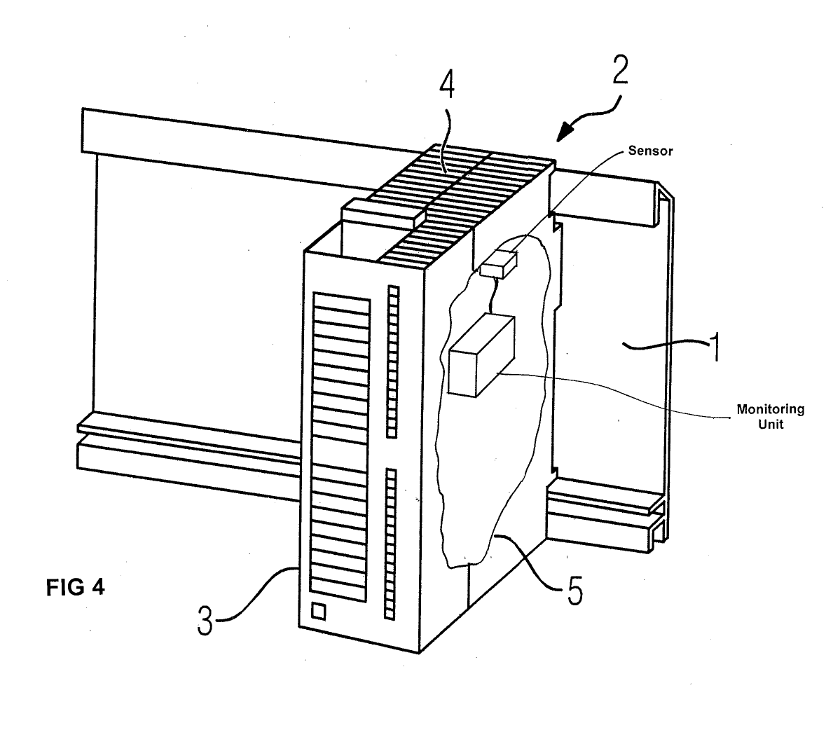

Therefore, the disclosed embodiments of the invention comprise an assembly for a modular automation device having a sensor, which is arranged in a housing capsule (3) of the assembly, for detecting the temperature (T_{det}) of the feed air in the housing capsule (3), where the feed air flows through air-inlet openings in the housing capsule (3), across components, and finally through air-outlet openings (4) in the housing capsule (3), and having a monitoring unit for evaluating the temperature (T_{det}) that is detected by the sensor. In accordance with the disclosed embodiments, at least one reference curve is stored in the monitoring unit, where the reference curve represents, for at least one performance parameter, the deviations in the detected temperature (T_{det}) or a reference temperature, which is associated with the detected temperature (T_{det}), as a function of a heat-up time or a cool-down time of the assembly, and where the monitoring unit is configured to determine the feed-air temperature (T_{z}) from the detected feed-air temperature (T_{det}) or the reference temperature and the time-dependent temperature deviation (Tₐ) via the reference curve (see FIG. 4).

As a result, it is possible to more accurately determine the feed-air temperature T_{z}.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An assembly for a modular automation device, comprising:
a housing capsule having air-inlet openings and air-outlet openings;
a sensor arranged in the housing capsule of the assembly, said sensor detecting a temperature (T_{det}) of feed air in the housing capsule, said feed air flowing through the air-inlet openings in the housing capsule, across components, and through the air-outlet openings in the housing capsule; and
a monitoring unit for evaluating the temperature (T_{det}) of the feed air detected by the sensor;
wherein at least one reference curve is stored in the monitoring unit, said reference curve representing, for at least one performance parameter, deviations in one of (i) the detected temperature (T_{det}) of feed air in the housing capsule and (ii) a reference temperature, which is associated with the detected temperature (T_{det}), as a function of one of (i) a heat-up time and (ii) a cool-down time of the assembly; and
wherein the monitoring unit is configured to determine the feed-air temperature (T_{z}) from one of (i) the detected feed-air temperature (T_{det}) and (ii) the reference temperature and the time-dependent temperature deviation (Tₐ) via the reference curve.

2. The assembly as claimed in claim 1, wherein the monitoring unit is further configured to calculate the feed-air temperature (T_{z}) from one of (i) the detected feed-air temperature (T_{det}) and (ii) the reference temperature and the temperature deviation (Tₐ) during the heat-up time of the assembly in accordance with the following relationship:
T_{z}=T_{det}−Tₐ
where:
$${T}_{a} = {T}_{s} + {T}_{e} \times ( 1 - {e}^{\frac{{t}_{h} - {t}_{0}}{T}} )$$
for t>t₀, and where:
tₕ is the heat-up time,
t₀ is a delay or dead time,
T is a time constant,
T_{z} is the calculated feed-air temperature,
T_{det} is one of (i) the detected feed-air temperature and (ii) the reference temperature,
Tₐ is the temperature deviation,
Tₛ is the temperature deviation at a beginning of the heating-up process, and
Tₑ is the temperature deviation at an end of the heating-up process.

3. The assembly as claimed in claim 1, wherein the monitoring unit is further configured to calculate the feed-air temperature (T_{z}) from one of (i) the detected feed-air temperature (T_{z}) and (ii) the reference temperature and the temperature deviation (Tₐ) during the cool-down time in accordance with the following relationship:
T_{z}=T_{det}−Tₐ
where:
$${T}_{a} = {T}_{ss} + {T}_{ee} \times {e}^{\frac{{t}_{k} - {t}_{0}}{T}}$$
for t>t₀, and where:
tₖ is the cool-down time,
t₀ is a delay or dead time,
T is a time constant,
T_{z} is the calculated feed-air temperature,
T_{det} is one of (i) the detected feed-air temperature and (ii) the reference temperature,
Tₐ is the temperature deviation,
Tₛₛ is the temperature deviation at a beginning of the cooling-down process, and
Tₑₑ is the temperature deviation at an end of the cooling-down process.

4. The modular automation device having a plurality of assemblies arranged on a support as claimed in claim 1.
